(19) United States
(12) Patent Application Publication
(10) Pub. No.: US 2007/0116457 A1
(43) Pub. Date: May 24, 2007

(54) Method for obtaining enhanced photography and device therefor

(76) Inventors: Peter Ljung, Malmo (SE); Jan Nilsson, Harlosa (SE)

Correspondence Address: MYERS BIGEL SIBLEY & SAJOVEC, P.A., P.O. BOX 37428, RALEIGH, NC, 27627, US

(21) Appl. No.: 11/285,561

(22) Filed: Nov. 22, 2005

(51) Int. Cl. G03B 35/00

(52) U.S. Cl. 396/324

(57) ABSTRACT

A method and device are provided for obtaining enhanced photography, and particularly three-dimensional and panorama photography, by combining a number of exposures taken at different positions and linking the exposures in dependence of movement of the device. An internal location reference is used. Automatic movement sensors and a processor are used to make calculations about relative distance and rotation. Exposures taken at different positions are linked together to form a combined representation of an object.

### FIELD OF THE INVENTION

The present invention relates to a method for obtaining enhanced photography, and particularly three dimensional and panorama photography by combining a number of exposures taken at different positions and linking the exposures in dependence of movement of the device. The invention also relates to a device implementing the method.

### BACKGROUND OF THE INVENTION

Three-dimensional photography has been used in the past as a means to obtain three-dimensional information from objects and environments as for example maps over earth or other planets. The method involves photographing the object from several locations and using location information and image processing to create a three dimensional model from the various exposures. The location information is retrieved from an external system, e.g. involving satellites or other known reference points.

It is also previously known to produce stereo images, i.e. a pair of images taken with a small distance corresponding to the distance between the eyes of a person. The method has been to use a fixture where a camera may be displaced in an accurate way, or using a dedicated stereo camera having two lenses with fixed distance.

Some cameras also have a panorama function, in which various exposures by means of software may be linked together to form a continuous wide angle image of an environment.

### SUMMARY OF THE INVENTION

Embodiments of the present invention provide the possibility of obtaining three-dimensional photography in a mobile device, such as a radio terminal incorporating a camera. With regard to 3D modeling, it is not practical to use an external system for location reference, since the objects to be photographed are usually small, and an external system such as GPS (Global Positioning System) does not have the required resolution to photograph smaller objects. With regard to stereo photography, it is not desired to provide two lenses in a small radio terminal. With regard to the panorama image, the current methods rely totally on the user's ability to direct the camera in the correct angles.

Embodiments of the present invention use an internal location reference for providing enhanced photography. Automatic movement sensors and a processor are used to make calculations about relative distance and rotation. Exposures taken at different positions are linked together to form a combined representation of an object.

In a first aspect the invention provides a method for obtaining a representation of an object with a device, comprising:

taking a first exposure of an object;

storing the position and angle of the device at the first exposure;

moving the device while sensing the relative distance and rotation of the device;

taking at least one further exposure of the object;

calculating the relative distance and rotation at the further exposure with reference to the first or previous exposure;

forming a combined representation of the object using exposures linked together with their relative distances and rotations.

The combined representation of the object may be formed as a three dimensional model.

According to some embodiments, more than two exposures are taken from different angles relative to the object.

In some embodiments, when the device has found a new suitable second position, the device automatically takes the further exposure.

Each exposure may be produced to contain depth information or three-dimensional information.

The combined representation of the object may be formed as a stereo picture.

Suitably, the device guides the user to a second position and angle relative to the object for taking the further exposure of the object.

The device may take the further exposure of the object automatically when the second position is reached.

The device may prompt the user to take the second exposure when the second position is reached.

The combined representation of the object may be formed as a panorama picture.

Suitably, the device guides the user to further angles relative to the object for taking the further exposures of the object.

The device may take said further exposures of the object automatically when a further angle is reached.

The device may take further exposures of the object automatically at predefined angles as the device is rotated.

In a second aspect the invention provides a device for obtaining a representation of an object, including: a camera unit capable of capturing an exposure as a digital representation of an object; memory means capable of storing a number of exposures; processor means capable of processing exposures; means for sensing relative distance and rotation, the device being adapted to:

store position and angle of the device at a first exposure taken of an object;

sense the relative distance and rotation of the device while moving the device;

calculating the relative distance and rotation with reference to the first or previous exposure at a further exposure taken of the object;

form a combined representation of the object using exposures linked together with their relative distances and rotations.

The device may have an operation mode for forming the combined representation of the object as a three dimensional model.

According to some embodiments, the processor means is adapted to process more than two exposures taken from different angles relative to the object.

The camera unit may be capable of capturing an exposure with depth information or three-dimensional information.

The device may have an operation mode for forming the combined representation of the object as a stereo picture.

Suitably, the device may be adapted to guide the user to a second position and angle relative to the object for taking the further exposure of the object.

The device may be adapted to take the further exposure of the object automatically when the second position is reached.

The device may be adapted to prompt the user to take the second exposure.

The device may have an operation mode for forming the combined representation of the object as a panorama picture.

Suitably, the device is adapted to guide the user to further angles relative to the object for taking the further exposures of the object.

The device may be adapted to take said further exposures of the object automatically when a further angle is reached.

The device may be adapted to take further exposures of the object automatically at predefined angles as the device is rotated.

Suitably, the means for sensing relative distance and rotation comprise a 3-axis accelerometer and a 3-axis gyro.

In a third aspect the invention provides a mobile radio terminal incorporating such a device.

Suitably, the means for sensing relative distance and rotation comprise a 3-axis accelerometer and a 3-axis gyro.

### BRIEF DESCRIPTION OF THE DRAWINGS

The invention will be described in detail below with reference to the attached drawings, in which:

FIG. 1 is a schematic diagram of a device showing components relevant to the present invention,

FIG. 2 is a schematic diagram of an object to be photographed and a device according to the invention with their respective coordinate systems, and

FIG. 3 is a schematic diagram of the steps for calculating relative rotation and distance.

### DETAILED DESCRIPTION OF EMBODIMENTS OF THE INVENTION

The invention relates to a method for obtaining enhanced photography and a device using the method, e.g. a digital camera. The digital camera may in turn be incorporated in a radio terminal, such as a mobile telephone, pager, communicator, electronic organizer, smart phone and the like.

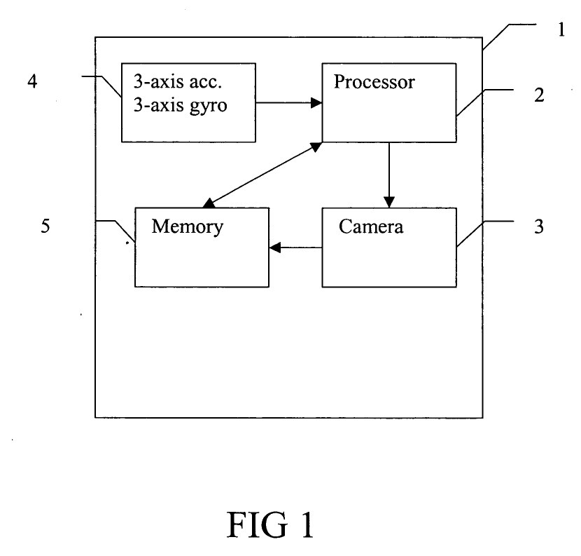

FIG. 1 illustrates relevant parts of a device according to embodiments of the invention. The device 1 comprises a processor 2 controlling various operations of the device. Particularly it is capable of controlling a camera 3 and of processing images stored in a memory 5.

The camera 3 is a digital camera comprising the conventional components, such as an optical system including a lens and a shutter, as well as a light sensitive sensor capturing exposures. The exposures result in a file of digital values stored in the memory. For simplicity, such a file will be referred to as an exposure in this specification. As the components of a camera as such may be conventional, they are not shown in detail in the drawings.

In some applications, the exposures may contain depth information themselves. Such exposures may be produced by means of a depth sensor using pulsed infrared light as commercialized by 3DV Systems, Israel. The exposures may also be three-dimensional models produced by means of conventional laser scanning techniques. In this case the invention is used to merge several representations (which may in themselves contain depth information) of the object.

The memory may be a working space of a memory incorporated in the device or may exist on a separate, removable memory card, storing working data as well as finished pictures and other representations.

The device further incorporates movement sensor means or system 4 including a translation sensor and a rotation sensor, suitably a 3-axis accelerometer and a 3-axis gyro. These components are known as such and commercially available from e.g. Analog Devices, Inc. and Murata Manufacturing Company, Ltd. As will be explained in further detail below, a 3-axis accelerometer is sensitive to acceleration in three spatial axes x, y, z. Each accelerometer measures a position change relative to time. By integration over time a relative distance of the movement may be obtained.

Similarly, a 3-axis gyro is sensitive to rotational changes around the three spatial axes x, y, z. Each gyro measures an angle change relative to time. By integration over time a relative rotation may be obtained.

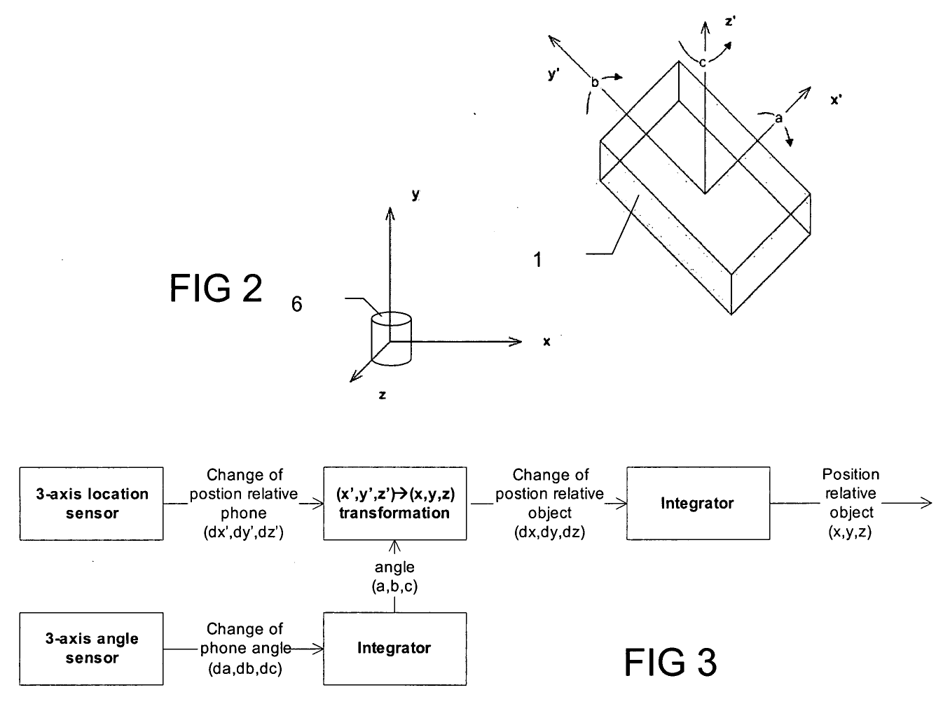

FIG. 2 illustrates the coordinate systems and rotations. An object 6 is shown at the origin of the coordinate system x, y, z. The object 6 is considered fixed, and the only movement to be considered is that of the device 1. The device 1 is at the origin of its own coordinate system x′, y′, z′. It is also required to know the direction in which the device is pointing. The rotations a, b, c around the axes x′, y′and z′, respectively, are measured. As explained below, the wanted information is the relative distance and rotation between two different positions of the device 1. Note that the acceleration along the 3-axes x′, y′, z′ is not sufficient information, since the device 1 is generally rotated during the movement, thereby also rotating the coordinate system x′, y′, z′ together with the sensing direction of the accelerometers and gyros.

Below is described in more detail how relative movement can be calculated from a 3 axis location sensor and a 3 axis rotation sensor according to an embodiment of the invention. This information relates to the measurement of relative movement used in the three operational modes described below.

To describe the solution we have to define coordinate systems relative the object 6 that we want to make a 3D representation of and a coordinate system relative the device 1 itself as is shown in FIG. 2. Coordinates in object space are represented in (x,y,z) axes. Coordinates in phone space are represented in (x′,y′,z′) axes.

The process for measurement of relative distance and rotation is shown in FIG. 3.

The location sensors of the 3-axis accelerometer output the relative change (dx′, dy′, dz′) of position in the device coordinate system (x′, y′, z′). The angle sensors of the 3-axis gyro output the relative change of angle (da, db, dc) of the device coordinate system (x′, y′, z′) relative to the object coordinate system (x,y,z). Integration of angle change gives an estimate of the angle of the device coordinate system (a, b, c) relative to the object coordinate system. To be able to estimate location of the device in the object coordinate system, relative change of location in the device coordinate system (dx′, dy′, dz′) is first transformed to the object coordinate system using the angle of the device coordinate system relative to the object coordinate system. Integration of relative change of location in the object coordinate system (dx′, dy′, dz′) finally gives an estimate of the location in the object coordinate system (x, y, z).

Transformation from the device space to the object space is a rotation transformation in three axes. Rotation around each axis is defined as follows.

$$Rx ( a ) = [ \begin{matrix}1 & 0 & 0 \\ 0 & cos ( a ) & sin ( a ) \\ 0 & - sin ( a ) & cos ( a )\end{matrix} ]$$

$$Ry ( b ) = [ \begin{matrix}cos ( b ) & 0 & - sin ( b ) \\ 0 & 1 & 0 \\ sin ( b ) & 0 & cos ( b )\end{matrix} ]$$

$$Rz ( c ) = [ \begin{matrix}cos ( c ) & sin ( c ) & 0 \\ - sin ( c ) & cos ( c ) & 0 \\ 0 & 0 & 1\end{matrix} ]$$

The resulting transformation formula is given by:
(x,y,z)=(x′,y′,z′)*Rx(a)*Ry(b)*Rz(c) (* stands for matrix multiplication)

A numerical integrator can e.g. be implemented as follows.
x(n)=x(n−1)+dx(n), y(n)=y(n−1)+dy(n), z(n)=z(n−1)+dz(n)
a(n)=a(n−1)+da(n), b(n)=b(n−1)+db(n), c(n)=c(n−1)+dc(n)
where n is sample number.

In other words, when the device moves from position 1 to position 2 during a time period t in the object space, the sensors' output (dx′, dy′, dz′) and (da, db, dc), are transformed and integrated over the time t to a relative movement a distance (x, y, z) and a rotation (a,b,c).

The information about relative movement can be exploited in three operational modes, 3D modeling, stereo pictures and panorama pictures.

3D modeling is used to create more or less complete 3D models by taking at least two, and preferably more exposures, of an object from different relative positions. In this way, the photographed object may be viewed from various angles.

The process for reconstruction of three dimensional objects from multiple camera views is common knowledge and will not be described in detail here. Briefly, photogrammetry techniques involve converting two-dimensional exposures of an object into a three-dimensional model. Using a digital camera with known characteristic (lens focal length, imager size and number of pixels), a minimum of two exposures of an object are needed. If you can indicate the same three object points in the two exposures and you can indicate a known dimension you can determine other 3D points in the exposures. If the exposures contain depth information or three-dimensional information, the exposures may be combined in a similar fashion. The process for obtaining the various exposures to create the model is as follows:
1. The user selects the operational mode for 3D modeling.
2. The user selects an object to model, e.g. a chair.
3. The user takes a first picture of the object.
4. At the moment of the first exposure, the device starts to measure the relative movement of the device.
5. The user moves the device and selects a new position and takes a further exposure. Alternatively, when the device has found a new suitable second position, the device automatically takes the second exposure.
6. The device calculates the relative movement and stores the position and angle of the device at the moment of the further exposure using the first exposure as a reference location.
7. Steps 5-6 are repeated until the object is covered from a desired number of angles. Subsequent exposures are preferably measured relative to the first exposure.
8. The device calculates a 3D model using the different exposures and their relative positions with reference to the first exposure.

The 3D model can be viewed from different angels on a display of the device. The three dimensional information can also be used for identification purposes, e.g. biometrical identification of human faces, generally identification of objects, games etc.

The operational mode for stereo pictures is used to create a pair of pictures, taken separately with an intra-distance equal to the distance between the eyes of a person. The process is as follows:
1. The user selects the operational mode for stereo pictures.
2. The user selects an object and makes one exposure, which is intended to represent location of a first eye, e.g. the left eye.
3. The device starts measuring relative movement and indicates in what direction and angle the device should be moved to take the second exposure, representing the second eye, e.g. the right eye. For instance, a display of the device may show an arrow pointing to the right.
4. The user moves the device following the guidance of the device.
5. When the correct second position is reached, at the correct relative distance and angle (substantially no rotation is generally desired), the device automatically takes the second exposure. This should now be translated horizontally exactly one eye distance to the right of the first exposure. Alternatively, when the device has reached the correct second position, the device prompts the user to take the second exposure.

A stereo picture consisting of a pair of linked exposures is now ready for display, which may be with conventional means.

In the operational mode for panorama pictures, pictures are linked side by side in a chain to form a wide picture covering a greater angle than with just one exposure. Generally, there should be at least two exposures. In principle, it is perfectly possible to make the picture covering a full 360° rotation. In this case, the object is the whole environment surrounding the user. The process is as follows:
1. The user selects the operational mode for panorama pictures.
2. The user selects a start angle by pointing the device and taking a first exposure.
3. The device starts the measurement of relative movement.
4. The user rotates the device slowly, possibly under guidance from the device. In this case mainly a rotation is desired
5. When the device has been rotated a suitable angle, so that an exposure at the position reached will have a suitable overlap with the previous exposure, the device automatically takes a further exposure.
6. The user continues to rotate the device to obtain an even wider angle, or selects to stop the process. Possibly, the user can select the number of exposures desired when the selecting the panorama picture mode. The device takes further exposures of the object automatically at predefined angles as the device is rotated.
7. The device links the exposure together using conventional software to obtain the desired panorama picture.

Embodiments of the present invention enable 3D modeling, stereo photography and panorama picture capabilities in a mobile device with only one camera and location sensors. The device may be implemented by means of suitable combinations of hardware and software.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

1. A method for obtaining a representation of an object with a device, comprising:
taking a first exposure of an object;
storing the position and angle of the device at the first exposure;
moving the device while sensing the relative distance and rotation of the device;
taking at least one further exposure of the object;
calculating the relative distance and rotation at the further exposure with reference to the first or previous exposure; and
forming a combined representation of the object using exposures linked together with their relative distances and rotations.

2. A method according to claim 1, wherein the combined representation of the object is formed as a three dimensional model.

3. A method according to claim 2, wherein more than two exposures are taken from different angles relative to the object.

4. A method according to claim 2, wherein, when the device has found a new suitable second position, the device automatically takes the further exposure.

5. A method according to claim 2, wherein each exposure is produced to contain depth information or three-dimensional information.

6. A method according to claim 1, wherein the combined representation of the object is formed as a stereo picture.

7. A method according to claim 6, wherein the device guides the user to a second position and angle relative to the object for taking the further exposure of the object.

8. A method according to claim 7, wherein the device takes the further exposure of the object automatically when the second position is reached.

9. A method according to claim 7, wherein the device prompts the user to take the second exposure when the second position is reached.

10. A method according to claim 1, wherein the combined representation of the object is formed as a panorama picture.

11. A method according to claim 10, wherein the device guides the user to further angles relative to the object for taking the further exposures of the object.

12. A method according to claim 11, wherein the device takes said further exposures of the object automatically when a further angle is reached.

13. A method according to claim 11, wherein the device takes further exposures of the object automatically at predefined angles as the device is rotated.

14. A device for obtaining a representation of an object, the device including:
a camera unit capable of capturing an exposure as a digital representation of an object;
a memory capable of storing a number of exposures;
a processor capable of processing exposures; and
a sensor system to sense relative distance and rotation;
wherein the device is adapted to:
store position and angle of the device at a first exposure taken of an object;
sense the relative distance and rotation of the device while moving the device;
calculate the relative distance and rotation with reference to the first or previous exposure at a further exposure taken of the object; and
form a combined representation of the object using exposures linked together with their relative distances and rotations.

15. A device according to claim 14, wherein the device has an operation mode for forming the combined representation of the object as a three dimensional model.

16. A device according to claim 15, wherein the processor is adapted to process more than two exposures taken from different angles relative to the object.

17. A device according to claim 14, wherein the camera unit is capable of capturing an exposure with depth information or three-dimensional information.

18. A device according to claim 14, wherein the device has an operation mode for forming the combined representation of the object as a stereo picture.

19. A device according to claim 18, wherein the device is adapted to guide the user to a second position and angle relative to the object for taking the further exposure of the object.

20. A device according to claim 19, wherein the device is adapted to take the further exposure of the object automatically when the second position is reached.

21. A device according to claim 19, wherein the device is adapted to prompt the user to take the second exposure.

22. A device according to claim 14, wherein the device has an operation mode for forming the combined representation of the object as a panorama picture.

23. A device according to claim 22, wherein the device is adapted to guide the user to further angles relative to the object for taking the further exposures of the object.

24. A device according to claim 23, wherein the device is adapted to take said further exposures of the object automatically when a further angle is reached.

25. A device according to claim 22, wherein the device is adapted to take further exposures of the object automatically at predefined angles as the device is rotated.

26. A device according to claim 14, wherein the sensor system comprises a 3-axis accelerometer and a 3-axis gyro.

27. A mobile radio terminal including a device to obtain a representation of an object, the device including:
a camera unit capable of capturing an exposure as a digital representation of an object;
a memory capable of storing a number of exposures;
a processor capable of processing exposures; and
a sensor system to sense relative distance and rotation;
wherein the device is adapted to:
store position and angle of the device at a first exposure taken of an object;
sense the relative distance and rotation of the device while moving the device;
calculate the relative distance and rotation with reference to the first or previous exposure at a further exposure taken of the object; and
form a combined representation of the object using exposures linked together with their relative distances and rotations.

28. A mobile radio terminal according to claim 27, wherein the sensor system comprises a 3-axis accelerometer and a 3-axis gyro.
